(19) United States
(12) Patent Application Publication
(10) Pub. No.: US 2014/0026028 A1
(43) Pub. Date: Jan. 23, 2014

(54) MANAGING WEBPAGE EDITS

(71) Applicants: Stefan Alfons Hepper, San Jose, CA (US); Jon Mark Harris, Raleigh, NC (US); Jeffrey Lawrence Sokolov, Lexington, MA (US)

(72) Inventors: Stefan Alfons Hepper, San Jose, CA (US); Jon Mark Harris, Raleigh, NC (US); Jeffrey Lawrence Sokolov, Lexington, MA (US)

(73) Assignee: INTERNATIONAL BUSINESS MACHINES CORPORATION, Armonk, NY (US)

(21) Appl. No.: 13/552,918

(22) Filed: Jul. 19, 2012

(51) Int. Cl. G06F 17/00

(52) U.S. Cl. 715/234

(57) ABSTRACT

Managing webpage edits includes making a change to a web component of a webpage in response to an editing process and providing a contact mechanism on the webpage to communicate with at least one process member involved in the editing process.

### BACKGROUND

The present invention relates to managing webpage edits, and more specifically, to managing webpage edits to facilitate communication between members involved in editing web components of webpages.

A web portal is a webpage that displays information from diverse sources in an organized way. Web portals are generally organized to provide a user with a starting point when the user is conducting a web search by providing information to the user in a manner that allows the user to find information easily. Information from diverse sources is displayed in web components of the webpage that are owned and/or managed by different parties. For example, in a financial web portal, one party may own and control a web component that displays information and links about current mortgage rates while another party owns and controls another web component that presents information dealing with current information about stocks.

### BRIEF SUMMARY

A method for managing webpage edits includes making a change to a first web component of a webpage in response to a first editing process and providing a contact mechanism on the webpage to communicate with at least one process member involved in the first editing process.

A system for managing webpage edits includes a processor programmed to display web components of a webpage, make a change to a first web component of a webpage in response to a first editing process, and display a contact mechanism in the webpage to communicate with at least one process member involved in the first editing process.

A computer program product includes a computer readable storage medium, the computer readable storage medium including computer readable program code embodied therewith, and the computer readable program code including computer readable program code to display a first web component and a second web component of a web portal and computer readable program code to display a contact mechanism in the web portal to communicate with process members involved in a first editing process to edit the first web component and a second editing process to edit the second web component.

### BRIEF DESCRIPTION OF THE SEVERAL VIEWS OF THE DRAWINGS

FIG. 1 is a diagram showing an illustrative system for managing webpage edits, according to one example of the principles described herein.

FIG. 2 is a diagram showing an illustrative webpage, according to one example of the principles described herein.

FIG. 3 is a diagram showing an illustrative collaboration tool, according to one example of the principles described herein.

FIG. 4a is a diagram showing an illustrative collaboration folder, according to one example of the principles described herein.

FIG. 4b is a diagram showing an illustrative collaboration folder filter, according to one example of the principles described herein.

FIG. 5 is a diagram showing an illustrative editing process, according to one example of the principles described herein.

FIG. 6 is a diagram showing an illustrative editing process, according to one example of the principles described herein.

FIG. 7 is a diagram showing an illustrative method for managing webpage edits, according to one example of the principles described herein.

FIG. 8 is a diagram showing an illustrative processor, according to one example of the principles described herein.

FIG. 9 is a diagram showing an illustrative flowchart of a process for managing webpage edits, according to one example of the principles described herein.

### DETAILED DESCRIPTION

The present specification describes a method and system for managing webpage edits such that the members of editing processes associated with the web components of the webpage may collaborate with one another.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

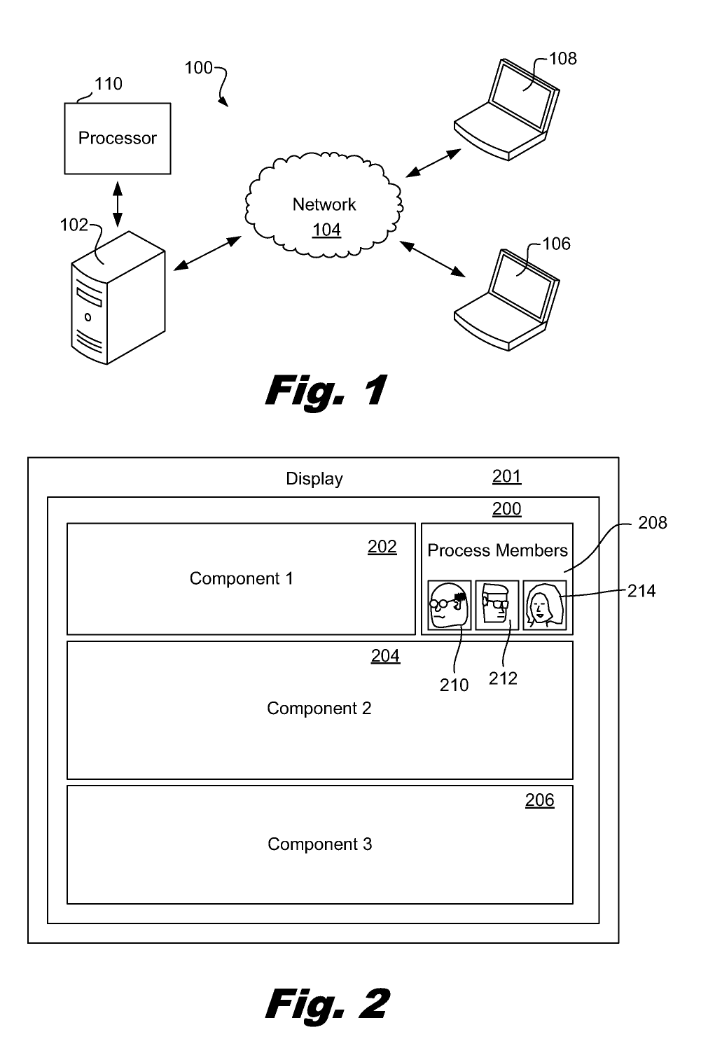

Referring now to the figures, FIG. 1 is a diagram showing an illustrative system (100) for managing webpage edits. The web components may be saved to memory in a server (102). Multiple parties may contribute to the web components over the network (104). For example, a first party may manage the information contained in a first web component by publishing updates to the first web component with a first client device (106). Likewise, a second party may manage the information contained in a second web component by publishing updates to the second web component with a second client device (108).

The web components may includes, at least in part, content from the respective parties, the webpage layout, the webpage design, the webpage's meta data, the webpage's title information, widgets, portlets, applications, features, other web components, or combinations thereof. In some examples, some of the web components are affected by other web components. For example, a widget of the webpage may extract content from other web components to provide a service to the webpage's users, and, as a consequence, the content in those web components may affect the widget. In other examples, the web components function, at least in part, independent of the other web components. In some examples, the management system stores versions of the webpage so that the users may review earlier version of the webpage. If questions arise while reviewing these versions, the users may be able to identify who made the changes based on user identifications tracked by the management system.

The client devices (106, 108) may be any device capable of running applications that allow the user to publish changes to their respective web components. For example, a non-exhaustive list of types of client devices that may be used includes personal computers, desktops, laptops, mobile devices, electronic tablets, cell phones, other client devices, or combinations thereof. Further, any type of network capable establishing communication between the client devices and the server may be used. For example, a non-exhaustive list of network types that may be used includes local area networks, wide area networks, private area networks, corporate networks, telecommunication networks, the internet, other networks, and combinations thereof. In some examples, the server (102) is located in a data center that maintains the webpage at least part of the webpage. The server (102) is in communication with a processor (110) that may be acted upon by machine readable instructions to change the web components in response to the publishing commands sent from the client devices (106, 108).

The different parties that control the web components may be different departments within an organization, different trade organizations, different owners of the web components, other parties, or combinations thereof. Each of the different parties may mange their web components independently of the other parties.

Each party that controls a web component may have an editing process for making changes to the web components. Each editing process may be independent of the other editing processes. For example, the first editing process by a first party may include additional tasks that a second editing process of a second party does not include. The first editing process may include receiving approval from a single manager of the first party to make changes to the web components while the second editing process may include receiving approval from multiple managers of the second party to make changes.

To facilitate communication between the parties, the processor (110) may cause a collaboration tool to be displayed on the webpage. Such a collaboration tool may track the changes made to the web components, track the contents of the webpage, and provide contact information for at least one process member involved in an editing process of one of the web components displayed on the webpage. Such a collaboration tool may display an image of the process members and provide other information that may facilitate communication with that process member. The information displayed in the collaboration tool may dynamically change as changes are made to the web components. The collaboration tool may allow the members of the different parties to communicate with each other so they may understand who made which changes to the webpage and why those changes were made.

FIG. 2 is a diagram showing an illustrative webpage (200). In this example, a display (201) in a user interface displays the webpage (200). The display (201) may be touch screen, a mouse controlled screen, a scroll ball controlled screen, another type of display, or combinations thereof.

In this example, the webpage (200) has a first web component (202), a second web component (204), and a third web component (206). Each of the web components may be operated by different parties that have independent editing processes. The webpage (200) also includes a collaboration tool (208) that contains images (210, 212, 214) of process members from different editing processes associated with their respective web components (202, 204, 206). For example, image (210) may be of a process member involved with editing the first web component (202), image (212) may be of a process member involved with editing the second web component (204), and image (214) may be of a process member involved with editing the third web component (206).

In the event that a party has a question or concern about content in one of the web components administered by another party, a member of that party may identify who to contact about the contents of the respective web component through the collaboration tool (208). The party member may select the image of the process member associated with the web component in question. In response to the image's selection, the collaboration tool (208) may display contact information about the process member and/or display with which web component the process member is associated. In some examples, the collaboration tool (208) provides a mechanism that allows the party member to communicate directly with the selected process member. In some examples, the mechanism is a chat mechanism that allows the party member to chat online with the process member through the collaboration tool, a call mechanism that allows the party member to call the process member through the collaboration tool, an email mechanism that allows the party member email to the process member through the collaboration tool, another communication mechanism, or combinations thereof.

In an example where a party member desires to discuss a matter about another party's web component, the party member may select images of the collaboration tool (208) to determine with which process members to discuss the matter. In response to selecting the appropriate process member, the collaboration tool (208) may display contact information such as the process member's name, phone number, the time zone in which the process member resides, the process member's availability, other information that may be relevant for contacting the process member, and combinations thereof. The collaboration tool (208) may also provide the party member with a chat button and/or an email button, either of which the party member may select to initiate contact with the appropriate process member. In some examples, the collaboration tool (208) may include buttons to facilitate other forms of communication. For example, the collaboration tool (208) may include a call button or a video button.

In some examples, the collaboration tool allows the party member and/or the process members to share their screens while they communicate with one another. In some examples, the collaboration tool (208) may allows the party member to access metadata about the web components in which the party member is interested in. In some examples, the collaboration tool (208) includes a feature that allows the process member to share and/or send metadata about a particular web component to the party member.

In some examples, a feature other than an image of the process members is used in the collaboration tool. For example, text may be used to identify web component parties. In such an example, when the appropriate text is selected, the collaboration tool (208) may display information about the process member or process members available to contact. In other examples, the feature includes symbols, markings, videos clips, icons, other features, or combinations thereof to represent the process members or the web components. In some examples, the feature is a visual symbol that a user may identify with the respective web component. For example, if a web component contains content relating to travel, the feature in the collaboration tool may include an image of an airplane so that a user unfamiliar with which parties manage which web components may easily identify the appropriate feature in the collaboration tool (208).

In some examples, the order of the images or features is dynamic. For example, the image or feature may be arranged according to frequency of use, such as positioning images or features to the left as they are used more frequently. In other examples, the image or features are positioned according the recent activity, such as positioning the images or features corresponding to the most recently changed web components to the left. In other examples, the user has an option to customize the arrangement as desired.

In some examples, just party members have access to the collaboration tool (208). The collaboration tool may be available to those who log in a predetermined code that gives party members more access to the webpage's information than is available to users in the general public. In such an example, the privacy of the process members may be increased, and the potential for non-collaboration communication requests may be reduced. However, in accordance with the principles described herein the collaboration tool (208) may be available to users from the general public as well.

In some examples, the collaboration tool (208) collapses and expands to display varying amounts of information. In a first state, the collaboration tool (208) may be minimized to show no information other than the presence of the collaboration tool (208). In another state, the collaboration tool (208) may display just information about process members from just a few process members that are deemed the most relevant according to an application policy and/or user preferences. In a fully expanded state, all of the process members may be displayed in the collaboration tool (208). Such examples of collapsing and expanding collaboration tool may free up the space on the webpage for other uses than those of the collaboration tool (208) until the user desires to interact with the collaboration tool (208).

The process members may be editors involved with the editing process, managers involved with the editing process, creators involved with the editing process, authors involved with the editing process, approvers involved with the editing process, other process members involved with the editing process, or combinations thereof. In some examples, the collaboration tool (208) allows a webpage user to select which type of process member is displayed in the collaboration tool (208). In some examples, the party that manages the web components selects which process member or process members are displayed in the collaboration tool (208). For example, the party may submit which process member should be contacted for specific changes as the changes are being made. In other examples, the parties specify that just specific process members should be displayed in the collaboration tool (208).

As a web component is changed in response to the editing process, the collaboration tool (208) may change the process members that are displayed. For example, if space in the collaboration tool (208) is limited such that there are more web components contained in the webpage than images of process members, the collaboration tool (208) may display process members involved in the most recent changes to the web components of the webpage (200). In other examples, the collaboration tool (208) displays images of process members who are associated with the most dynamic web components of the webpage (200). In yet other examples, the collaboration tool (208) displays images of process members who are associated with the most content rich web components of the webpage (200). In some examples, the user customizes the collaboration tool (208) to display images of process members based on selected preferences, such as most recently modified web component, most content rich web components, most dynamic web components, other parameters, or combinations thereof. In some examples, the user has an option to select which web components that the user desires the collaboration tool (208) to display regardless of the changes made to the webpage.

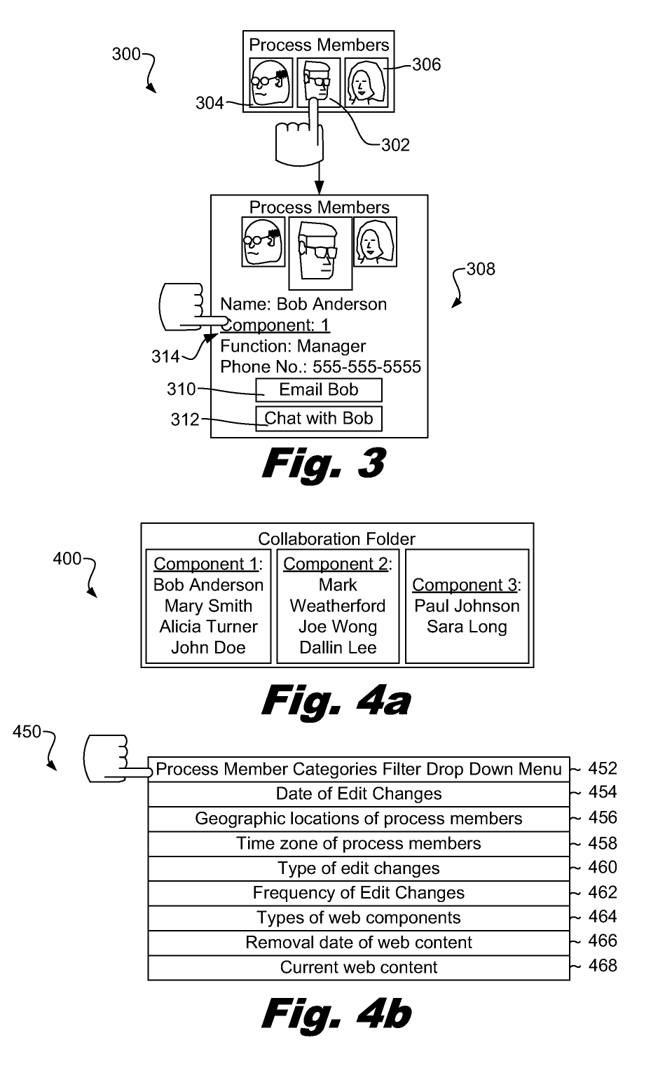

FIG. 3 is a diagram showing an illustrative collaboration tool (300). In this example, first image (302) is selected from the images (302, 304, 306) displayed in the collaboration tool (300). The first image (302) may be selected with a touch input, a curser input, another type of input, voice recognition input, or combinations thereof according to the type of display upon which the collaboration feature is depicted.

In response to the first image's selection, the collaboration tool (300) may enlarge the first image (302) to indicate its selection and display contact information (308). In this example, the name of the process member associated with the selected image (302) is displayed. Also, the web component with which the process member is associated is also displayed. In the example of FIG. 3, the process member's job function in the editing process and the process member's phone number are displayed.

In the illustrated example, other communication mechanisms (310, 312) for contacting the process member are also displayed in response to selecting the first image (302). For example, a first communication mechanism (310) may provide an email button that, if selected, may open an email window already addressed to the process member. Also, in the illustrated example, a second communication mechanism (312) provides a chat button that, if selected, may open a communication channel to allow the user to chat online with the process member. In this manner, the user may quickly communicate with the process member without having to search for contact information elsewhere.

In the example of FIG. 3, the text identifying the web component contains a link (314) that, if selected, may provide more information about the web component. For example, the link (314) may provide an editing history that indicates when the web component was last updated. In other examples, the link (314) provides a list of other members involved with the web component's editing process that are available to contact. For example, all of the editors, authors, managers, creators, approvers, other members of the editing process, a subset thereof, or combinations thereof may be provided through the link (314). In some examples, information provided with the link displays information that is intended to answer the user's most frequent questions, such as an editing history or other relevant information. In some examples, a process member posts comments to explain changes. In some examples, the process member posts such a comment to respond to multiple inquiries about an issue or a recent update or to anticipate foreseeable questions.

In some examples, the selection of the link (314) causes the additional information to open in the same window that also contains the collaboration tool (300). In other examples, the link is a hyperlink that opens a new window where the additional information is displayed.

FIG. 4a is a diagram showing an illustrative collaboration folder (400). A processor that is caused to operate the collaboration tool may have access to the collaboration folder (400) that contains a list of process members grouped into categories. In the example of FIG. 4a, the categories are by arranged by web components. The processor may dynamically select process members from the collaboration folder (400) based on factors determined by a selection policy.

In some examples, a selection policy is based on the content displayed on the webpage. For example, the policy may include that if a web component is removed from the webpage, that the process members be discontinued from being displayed within the collaboration tool. In other examples, the process members involved with the editing process of a removed web component remains displayed in the collaboration tool for a predetermined time period to allow other users to contact the process members about the removal. Such a policy may also be based on collaboration activity of the process members, preferences of the parties associated with the web components, preferences of the user, recent activity concerning a web component, other factors, or combinations thereof.

As a consequence, not all of the process members involved with every web component on the webpage need be displayed in the collaborative tool. In some examples, just the process members who are relevant to the contents currently displayed in the webpage are present in the collaboration tool. As the webpage's content changes through changes in the web components, the policy may have different process members displayed in the collaboration tool. In some examples, the arrangement of the process members displayed in the collaboration tool changes as the content of the webpage changes.

FIG. 4b is a diagram showing an illustrative collaboration folder filter (450), according to one example of the principles described herein. In this example, a user may select a drop down menu button (452) of the filter (450) to view categories with which the user may filter process members. In this example, the categories include dates of edits changes (454), geographic locations of process members (456), time zone of process members (458), type of edit change (460), frequency of edit changes (462), types of web component (464), removal date of web content (466), and current web content (468). In some examples, the user may filter the process members with other categories. In some examples, the user may create categories which with the user may filter the process members.

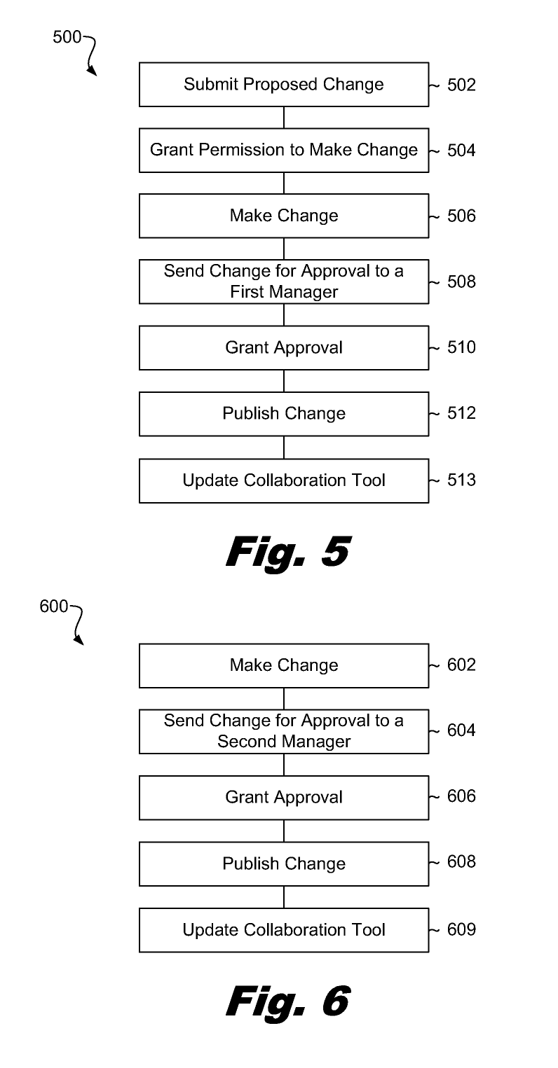

FIG. 5 is a diagram showing an illustrative editing process (500). In this example, the editing process (500) is for making changes to a particular web component displayed in the webpage of a specific party. In this example, the editing process (500) includes submitting (502) a proposed change from an editor to an approver or a manager within the party. The manager or approver may grant (504) permission to make the change to the editor. The editor may make (506) the change and send (508) the change for approval to a first manager. In some examples, this approval is sent to the same manager or approver who granted the original permission to make the change, to a different manager or approver, to additional managers and/or approvers, or combinations thereof. The requested approvers and/or mangers may grant (510) approval. In response to this approval, the editor may publish (512) the change to the webpage. The collaboration tool may be updated (513) in response to publishing the changes.

In some examples, the approver is a manager within a department that maintains the web component within an entity that owns the web component. In other examples, the approvers are selected from other departments within the entity. For example, some changes may need to involve personnel from a marketing department, a finance department, a human resource department, a legal department, an engineering department, a programming department, other departments within the entity, or combinations thereof. In some examples, corporate officers or an entity stakeholder may be part of the editing process as approvers. In some examples, the editing process may be a formal editing process, such as a process that includes gathering signatures for approval, discussion in committee meetings, other formalities, or combinations thereof. In some other examples, the editing process is informal where such formalities are not necessary for approval.

In some examples, others involved in the entity, such as personnel from other departments within the entity may make the proposal for the changes to the web components. In such an example, after granting (504) the permission to make the change, the task of making (506) the change may be assigned to a web component editor.

FIG. 6 is a diagram showing an illustrative editing process (600). In this example, the editing process (600) is for making changes to a different web component that is different than the web component referenced in the description of the editing process of FIG. 5. In the example of FIG. 6, the editing process (600) includes making (602) a change to a web component and sending (604) the change for approval to a second manager. In some examples, the second manager is different from the first manager. Further, the second manager may not be involved in the editing process depicted in FIG. 5. The requested approvers and/or mangers may grant (606) approval. In response to this approval, the editor may publish (608) the change to the webpage. The collaboration tool may be updated (609) in response to publishing the changes.

In examples where a user from an entity with a stake in the webpage wants to discuss a matter about a web component with a process member associated with that web component, the user may contact the process member through the collaboration tool. In some examples, the user has an option to request changes to another's web component through the collaboration tool.

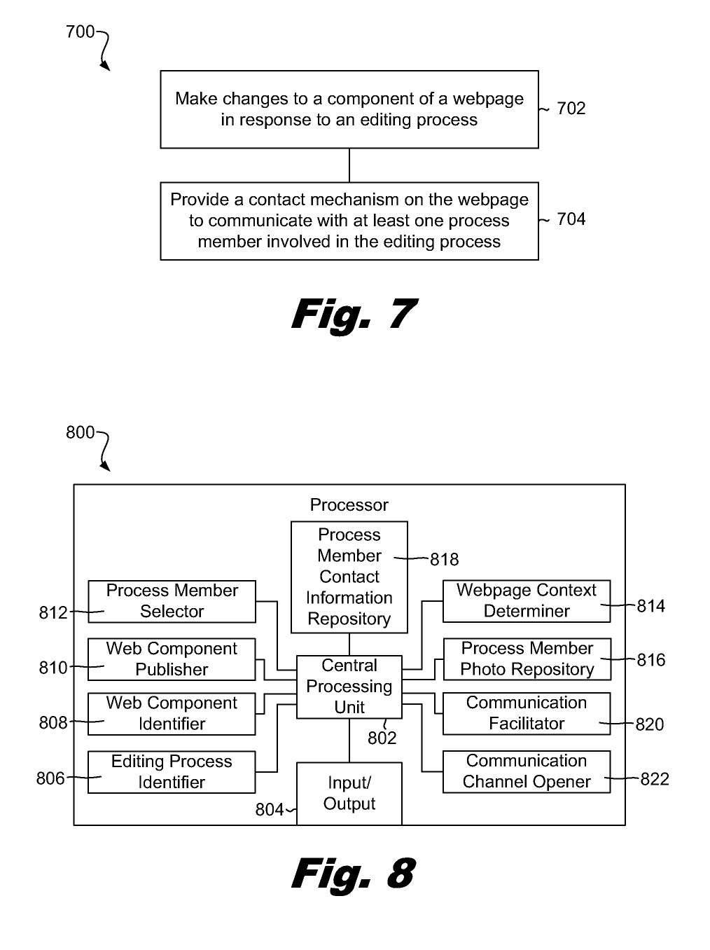

FIG. 7 is a diagram showing an illustrative method (700) for managing webpage edits. In this example, the method (700) includes making (702) changes to a web component of a webpage in response to an editing process and providing (704) a contact mechanism on the webpage to communicate with at least one process member involved in the editing process.

In some examples, the webpage is a web portal. The web portal may have multiple web components that are managed by different parties. For example, the webpage may have a second web component with a second editing process. This second web component may be owned and/or controlled by an entity that is different than the entity that owns and/or controls the first web component. The second editing process may have at least one different process member than those involved in the first editing process. Further, the first web component may be managed with a first manager, and the second web component may be managed with a second manager that is different than the first manager. Further, the first editing process may include at least one task that is different from editing tasks of the second editing process.

The method may also include dynamically selecting process members to display in the collaboration tool. The process member may be dynamically selected based on the content of the webpage. In some examples, the process member may be an editor, a manager, an approver, a creator, another involved in the editing process, or combinations thereof.

A creator may be an author or co-author of content for a web component. In some examples, the creator is an author of an unedited draft of the content. An editor may revise the content after the creator creates the content.

The contact mechanism may be displayed in the collaboration tool. In some examples, the contact mechanism is an email mechanism, a chat mechanism, a phone mechanism, a fax mechanism, a texting mechanism, a conferencing mechanism, a video mechanism, a display of process members, a display of contact information, another communication mechanism, or combinations thereof. In some examples, the method includes opening a communication channel with the process member in response to a request to active the contact mechanism. The communication channel may be part of a chat mechanism. The collaboration tool may allow the members of the parties to discuss changes that were made or not made to the webpage. In some examples, the collaboration tool allows the users to discuss how the changes evolved during the editing process by providing the user with an ability to discuss the changes with each member of the editing process. In some examples, the members of different editing processes coordinate their efforts when making edits that may affect the other web components. In some examples, the different parties may discuss their proposed changes, share ideas, and/or share their vision of the webpage with the other parties.

In some examples, the contact mechanism has a link to contact information of that at least one process member. In some examples, the contact mechanism has a collaboration folder with the process member grouped into categories. The collaboration tool may allow the users to filter through the process members to select the type of process member with which they want to communicate. For example, the collaboration tool may allow the user to filter by creator, author, editor, manager, approver, other process member, or combinations thereof. Further, the collaboration tool may further allow the user to filter by the dates of edits changes, geographic locations of process members, time zone of process members, type of edit change, frequency of edit changes, types of web component, removal date of web content, current web content, changes in editing process, or combinations thereof.

In some examples, the collaboration tool is integrated into a webpage management system. The management system may track the changes made to the webpage and track who made those changes with a user identification. The management system may be in communication with the collaboration tool and associate the respective process member with the user identification to ensure that an appropriate process member is identified in the collaboration tool.

FIG. 8 is a diagram showing an illustrative processor (800). In this example, the processor (800) has a central processing unit (CPU) (802) that is in communication with an input/output (804). The processor (800) may be part of a server that operates at least a portion of a webpage. Commands to publish content to web components of the webpage may be received with the input/output (804) through editing processes that are unique to each of the web components.

In FIG. 8, the processor (800) has an editing processes identifier (806) that determines when the processor (800) has received a command to publish an updated web component with at least one change. A web component identifier (808) may determine to which web component the publishing command is intended, and a web component publisher (810) may publish the updated content to the web component.

In response to making a change to a web component, a process member selector (812) may determine whether to make a change to the collaboration tool displayed on the webpage. The process member selector (812) may select a process member that was involved in the editing process of the changed web component. The process member selector (812) may select a process member based on policies that may include recent activity of a web component, the level of involvement a process member has within the editing process, preferences of the entity controlling the web component, other factors, or combinations thereof.

The process member selector (812) may use a webpage content determiner (814) to determine which process member to display based on the selection policy. In response to the selection of a process member, the process member's photo and contact information may be display in the collaboration tool. The processor (800) may gain access to the process member's photo with a process member photo repository (816) and the contact information may be pulled from a process member contact information repository (818).

The processor (800) may also cause a communication facilitator (820) to provide mechanisms for a user to contact the selected process member. In examples where a user determines to contact the process member, a communication channel opener (822) may open a communication channel between a client device used by the user and a client device used by the process member.

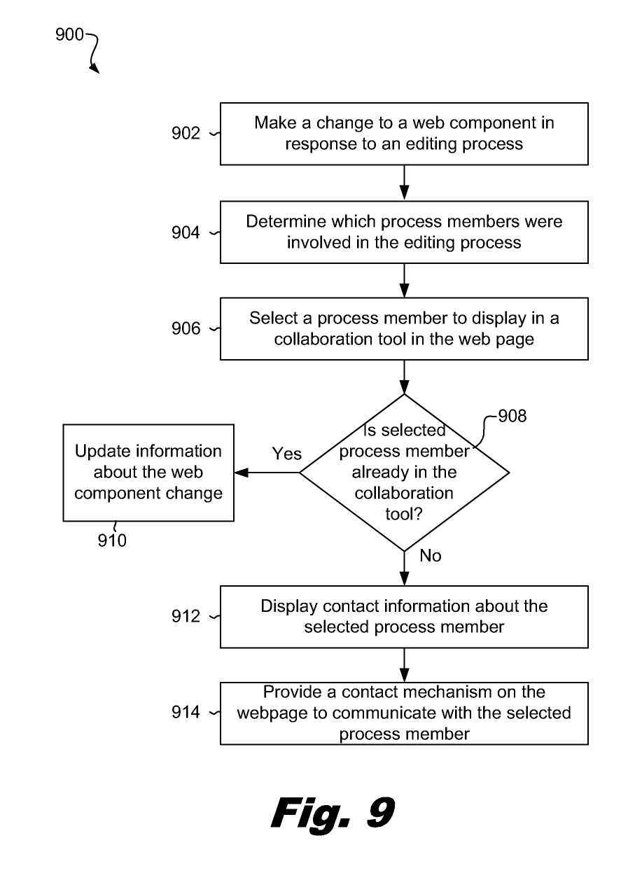

FIG. 9 is a diagram showing an illustrative flowchart (900) of a process for managing webpage edits. In this example, the process includes making (902) a change to a web component in response to an editing process. After making the change, the process may further include determining (904) which process member were involved in the editing process and selecting (906) a process member to display in a collaboration tool in the web page.

After selecting the process member, the process may determine (908) whether the selected process member is already displayed in the collaboration tool. If the process member is already displayed in the collaboration tool, the process may include updating (910) information about the web component change. If the process member is not already displayed, the process may include displaying (912) the contact information about the selected process member in the collaboration tool and providing (914) the contact mechanism on the webpage to communicate with the selected process member.

While the above examples have been described with reference to particular types of webpages and particular types of web components, any type of webpage or type of web component may be used in accordance to the principles described herein. Also, while the above examples have been described herein with specific editing processes and specific tasks within those editing process, any editing process or tasks within the editing process may be used in accordance with the principles described herein.

While particular types of communication mechanism have been described with the above examples, any type of communication mechanism compatible with the principles described herein may be used. While particular selection policies have been described with the above examples, any selection policy may be used with the principles described herein. While particular types of process members have been described with the above examples, any type of process member in accordance with the principles described herein may be used. While the collaboration tool in the above examples has been described with specific layouts and arrangement, any suitable layout or arrangement compatible with the principles described herein may be used. While the collaboration tool has been depicted in certain locations of the webpage, the collaboration tool may be depicted in any position within the webpage compatible with the principles described herein.

The descriptions of the various examples of the present invention have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

What is claimed is:

1. A method for managing webpage edits, comprising:
making a change to a web component of a webpage in response to an editing process; and
providing a contact mechanism on said webpage to communicate with at least one process member involved in said editing process.

2. The method of claim 1, wherein said at least one process member is a creator, an editor, a manager, an approver, or combinations thereof.

3. The method of claim 1, further comprising dynamically selecting said at least one process member based on content of said webpage.

4. The method of claim 1, wherein said webpage comprises a second web component with a second editing process.

5. The method of claim 4, wherein said second editing process comprises at least one different process member than those involved in said editing process.

6. The method of claim 4, wherein said web component is managed with a first manager and said second web component is managed with a second manager different than said first manager.

7. The method of claim 4, wherein said editing process comprises at least one task that is different from editing tasks of said second editing process.

8. The method of claim 1, wherein said webpage is a web portal.

9. The method of claim 1, wherein contact mechanism comprises a link to contact information of said at least one process member.

10. The method of claim 1, further comprising opening a communication channel with said at least one process member in response to a request to activate said contact mechanism.

11. The method of claim 10, wherein said communication channel is a chat mechanism.

12. The method of claim 1, wherein said contact mechanism is an email mechanism.

13. The method of claim 1, wherein said contact mechanism comprises an image of said at least one process member.

14. The method of claim 1, wherein said contact mechanism comprises a collaboration folder with process members grouped into categories.

15. The method of claim 14, wherein said categories comprises dates of edits changes, geographic locations of process members, time zone of process members, type of edit change, frequency of edit changes, types of web component, removal date of web content, current web content, or combinations thereof.

16. A system for managing webpage edits, comprising:
a processor programmed to
display a first web component of a webpage;
make a change to said first web component in response to a first editing process; and
display a contact mechanism in said webpage to communicate with at least one process member involved in said first editing process.

17. The system of claim 16, wherein said processor is further programmed to facilitate communication with said at least one process member with said contact mechanism.

18. A computer program product, comprising:
a computer readable storage medium, said computer readable storage medium comprising computer readable program code embodied therewith, said computer readable program code comprising:
computer readable program code to display a first web component and a second web component of a web portal; and
computer readable program code to display a contact mechanism in said web portal to communicate with process members involved in a first editing process to edit said first web component and a second editing process to edit said second web component.

19. The computer program product of claim 18, wherein said process members are selected from a group consisting of creators, editors, managers, approvers, or combinations thereof.

20. The computer program product of claim 18, computer readable program code to facilitate communication with at least one of said process member with said contact mechanism.
